(19) United States
(12) Patent Application Publication
(10) Pub. No.: US 2022/0399546 A1
(43) Pub. Date: Dec. 15, 2022

(54) PROTECTIVE FILM FOR LITHIUM ELECTRODE AND LITHIUM ELECTRODE FOR LITHIUM SECONDARY BATTERY COMPRISING SAME

(71) Applicants: HYUNDAI MOTOR COMPANY, Seoul (KR); KIA CORPORATION, Seoul (KR); POSTECH Research and Business Development Foundation, Pohang-si (KR)

(72) Inventors: Sam Ick Son, Suwon-si (KR); Soo Jin Park, Pohang-si (KR); Gyu Jin Song, Pohang-si (KR); Dong Yeob Han, Pohang-si (KR)

(73) Assignees: Hyundai Motor Company, Seoul (KR); Kia Corporation, Seoul (KR); POSTECH Research and Business Development Foundation, Pohang-si (KR)

(21) Appl. No.: 17/835,136

(22) Filed: Jun. 8, 2022

(30) Foreign Application Priority Data
Jun. 11, 2021 (KR) 10-2021-0075802

(51) Int. Cl. H01M 4/62; H01M 10/0525; H01M 4/04; H01M 4/134; H01M 4/1395; C08J 5/18; H01M 4/38

(52) U.S. Cl. CPC H01M 4/628; H01M 10/0525; H01M 4/0435; H01M 4/134; H01M 4/1395; C08J 5/18; H01M 4/382; H01M 2004/021

(57) ABSTRACT

The present disclosure provides a protective film for a lithium electrode and a lithium electrode for a lithium secondary battery including the same. The protective film includes a first layer, which includes polyvinyl alcohol (PVA) and polyacrylic acid (PAA) and is porous, and a second layer, which is disposed on the first layer, includes a styrene-butadiene-styrene block copolymer, and is porous.

### CROSS-REFERENCE TO RELATED APPLICATION

This application claims under 35 U.S.C. § 119(a) the benefit of priority to Korean Patent Application No. 10-2021-0075802, filed on Jun. 11, 2021 in the Korean Intellectual Property Office, the entire contents of which are incorporated herein by reference.

### BACKGROUND

### (a) Technical Field

The present disclosure relates to a protective film for a lithium electrode and a lithium electrode for a lithium secondary battery including the same.

### (b) Background Art

A lithium secondary battery is a secondary battery having the highest energy density among currently commercially available secondary batteries, and may be used in various fields, such as those of electric vehicles.

The anode of a commercially available lithium secondary battery includes graphite as an active material. Although graphite has a theoretical capacity of 372 mAh/g, limitations are imposed on application thereof to electric vehicles and large-capacity energy storage systems requiring high energy density.

Lithium metal is receiving attention as an anode material capable of realizing high energy density due to the high theoretical capacity of 3860 mAh/g and very low redox potential (−3.04V vs. S.H.E.) thereof.

However, lithium metal is still unsatisfactory with regard to lifetime and safety aspects, such as the risk of internal short circuit, depletion of electrolytic solution, fire, etc. because lithium dendrites randomly grow during charging and discharging.

Accordingly, thorough research is ongoing in order to develop a material capable of inhibiting the growth of lithium dendrites and stably growing lithium.

The information disclosed in the Background section above is to aid in the understanding of the background of the present disclosure, and should not be taken as acknowledgement that this information forms any part of prior art.

### SUMMARY OF THE DISCLOSURE

Accordingly, an object of the present disclosure is to provide a protective film for a lithium electrode that is capable of inducing stable growth of lithium during charging and discharging, and a lithium electrode for a lithium secondary battery including the same.

Another object of the present disclosure is to provide a protective film for a lithium electrode that is capable of inhibiting the growth of lithium dendrites during charging and discharging, and a lithium electrode for a lithium secondary battery including the same.

The objects of the present disclosure are not limited to the foregoing, and will be able to be clearly understood through the following description and to be realized by the means described in the claims and combinations thereof.

The present disclosure provides a protective film for a lithium electrode, including a first layer, which includes polyvinyl alcohol (PVA) and polyacrylic acid (PAA) and is porous, and a second layer, which is disposed on the first layer, includes a styrene-butadiene-styrene block copolymer, and is porous.

The first layer may include polyvinyl alcohol and polyacrylic acid at a mass ratio of 1:3 to 3:1.

The first layer may have a structure formed by accumulating nanofibers in which a spinning solution including polyvinyl alcohol and polyacrylic acid is electrospun.

The first layer may have a thickness of 1 μm to 20 μm.

The first layer may have a porosity of 50% to 98%.

The second layer may have a structure formed by accumulating nanofibers in which a spinning solution comprising a styrene-butadiene-styrene block copolymer is electrospun.

The second layer may have a thickness of 1 μm to 20 μm.

The second layer may have a porosity of 50% to 90%.

In addition, the present disclosure provides a lithium electrode for a lithium secondary battery, including a plate-shaped lithium metal and the protective film described above disposed on the lithium metal, wherein the first layer of the protective film is disposed on the lithium metal.

In addition, the present disclosure provides a method of manufacturing a protective film for a lithium electrode, including preparing a first spinning solution including polyvinyl alcohol and polyacrylic acid, forming a first layer, which is porous, by electrospinning the first spinning solution on a substrate, preparing a second spinning solution including a styrene-butadiene-styrene block copolymer, and forming a second layer, which is porous, by electrospinning the second spinning solution on the first layer.

The first spinning solution may include 8 wt % to 15 wt % of polyvinyl alcohol and polyacrylic acid.

The first spinning solution may include polyvinyl alcohol and polyacrylic acid at a mass ratio of 1:3 to 3:1.

In the manufacturing method according to the present disclosure, the first spinning solution may be electrospun under a voltage of 15 kV to 30 kV.

In the manufacturing method according to the present disclosure, after electrospinning the first spinning solution, the resulting product may be hot-rolled to form the first layer.

The second spinning solution may include 9 wt % to 15 wt % of the styrene-butadiene-styrene block copolymer.

In the manufacturing method according to the present disclosure, the second spinning solution may be electrospun under a voltage of 15 kV to 30 kV.

According to the present disclosure, lithium ions can smoothly move through the pores in the protective film during charging and discharging, and the deposition density of lithium metal is greatly improved, so the growth of lithium can be efficiently controlled.

According to the present disclosure, a lithium secondary battery having high charge/discharge coulombic efficiency, a long lifetime, and excellent stability can be obtained.

The effects of the present disclosure are not limited to the foregoing, and should be understood to include all effects that may be reasonably anticipated from the following description.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a cross-sectional view showing a lithium secondary battery according to one exemplary embodiment of the present disclosure;

FIG. 2 shows the result of analysis of a cross section of a protective film according to an exemplary embodiment of the present disclosure using a scanning electron microscope;

FIG. 3 shows the result of evaluation of the electrochemical lifetime of the asymmetric cell according to Example;

FIG. 4 shows the result of evaluation of the electrochemical lifetime of the asymmetric cell according to Comparative Example 1;

FIG. 5 shows the result of evaluation of the electrochemical lifetime of the asymmetric cell according to Comparative Example 2;

FIG. 6 shows the result of evaluation of the electrochemical lifetime of the asymmetric cell according to Comparative Example 3; and

FIG. 7 shows the result of evaluation of the electrochemical lifetime of the asymmetric cell according to Comparative Example 4.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

FIG. 1 is a cross-sectional view showing a lithium secondary battery according to the present disclosure. The lithium secondary battery may include a cathode 10, a lithium electrode 20, and a separator 30 disposed between the cathode 10 and the lithium electrode 20. Moreover, all or part of the cathode 10 and the separator 30 may be impregnated with an electrolyte (not shown).

Cathode

The cathode 10 may include a cathode active material, a binder, a conductor, and the like.

The cathode active material may include at least one selected from the group consisting of lithium cobalt oxide, lithium nickel cobalt manganese oxide, lithium nickel cobalt aluminum oxide, lithium iron phosphorus oxide, lithium manganese oxide, and combinations thereof. However, the cathode active material is not limited thereto, and any cathode active material available in the art may be used.

The binder is added to facilitate binding of the cathode active material to the conductor and the like and binding to a current collector, and examples thereof may include polyvinylidene fluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene monomer (EPDM) rubber, sulfonated EPDM, styrene butadiene rubber, fluororubber, various copolymers, and the like.

The conductor is not particularly limited, so long as it exhibits conductivity without causing a chemical change in the battery. Examples thereof may include graphite such as natural graphite or artificial graphite, carbon-based materials such as carbon black, acetylene black, Ketjen black, channel black, furnace black, lamp black, thermal black, etc., conductive fibers such as carbon fibers or metal fibers, metal powder such as carbon fluoride, aluminum, nickel, etc., conductive whiskers such as zinc oxide, potassium titanate, etc., conductive metal oxides such as titanium oxide, etc., conductive materials such as polyphenylene derivatives, etc., and the like.

Lithium Electrode

The lithium electrode 20 may include a plate-shaped lithium metal 21 and a protective film 22 disposed on the lithium metal 21.

The lithium metal 21 may include lithium or a lithium alloy.

The lithium alloy may include an alloy of lithium and a metal or metalloid capable of alloying with lithium. The metal or metalloid capable of alloying with lithium may include Si, Sn, Al, Ge, Pb, Bi, Sb, and the like.

The lithium metal 21 has a high electric capacity per unit weight and is thus advantageous for the formation of a high-capacity battery. However, the lithium metal 21 may cause a short circuit between the cathode 10 and the lithium electrode 20 due to the growth of lithium dendrites during deposition and dissolution of lithium ions. Moreover, since the lithium metal 21 is highly reactive with the electrolyte, the lifetime of the battery may be reduced due to side reactions therebetween. Meanwhile, the lithium metal 21 undergoes a large volume change during charging and discharging, so lithium dissolution may occur from the lithium electrode 20.

The present disclosure is intended to solve the above problems by forming a protective film 22 having various functionalities on the lithium metal 21.

The protective film 22 includes a first layer 221, which includes polyvinyl alcohol (PVA) and polyacrylic acid (PAA) and is porous, and a second layer 222, which is disposed on the first layer 221, includes a styrene-butadiene-styrene block copolymer, and is porous.

Although a conventional protective film for lithium metal is generally provided in the form of a film, a porous protective film 22 is used in the present disclosure. Specifically, the protective film 22 has high porosity, so lithium ions are capable of moving smoothly without the need to use an additional ion-conductive lithium material. Also, the protective film 22 is advantageous in realizing a lithium secondary battery having high energy density because it is able to efficiently store the lithium metal deposited during charging.

Moreover, in the present disclosure, the protective film 22 is provided in the form of multiple layers, so it is porous but effectively prevents contact between the lithium metal 21 and the electrolyte (not shown).

The first layer 221 has high lithium-ion conductivity, thereby inducing stable growth of lithium metal. The first layer 221 may include a polyacrylic acid exhibiting high lithium-ion conductivity and very free ion movement by virtue of the flexible structure thereof. Here, polyacrylic acid has high lithium-ion conductivity, but, with regard to mechanical properties thereof, lacks the ability to maintain a predetermined shape. Hence, the present disclosure uses polyvinyl alcohol having high rigidity and thus superior mechanical strength, in addition to polyacrylic acid. Specifically, by mixing polyacrylic acid having high lithium-ion conductivity and polyvinyl alcohol having superior mechanical strength at a specific mixing ratio, the present disclosure is capable of exhibiting the advantages of each. Here, the first layer 221 may include polyvinyl alcohol and polyacrylic acid at a mass ratio of 1:3 to 3:1.

The second layer 222 has extensibility and is configured to physically inhibit the growth of unnecessary lithium dendrites during unnecessary battery charging. Here, extensibility is a property indicating the ability to be stretched without breaking by 50% or more, or 100% or more in at least one direction among a thickness direction, a longitudinal direction, and the like. The second layer 222 may include a styrene-butadiene-styrene block copolymer having the extensibility described above.

A method of manufacturing the protective film 22 includes preparing a first spinning solution including polyvinyl alcohol and polyacrylic acid, forming a first layer 221, which is porous, by electrospinning the first spinning solution on a substrate, preparing a second spinning solution including a styrene-butadiene-styrene block copolymer, and forming a second layer 222, which is porous, by electrospinning the second spinning solution on the first layer 221.

The first spinning solution may be prepared by dissolving polyvinyl alcohol and polyacrylic acid in an aqueous solvent, such as water, or the like.

The first spinning solution may include 8 to 15 wt % of polyvinyl alcohol and polyacrylic acid. If the combined amount of polyvinyl alcohol and polyacrylic acid is less than 8 wt %, it is difficult to realize the form of the first layer 221, whereas if it exceeds 15 wt %, the first layer 221 may be non-uniformly formed.

The first spinning solution may include polyvinyl alcohol and polyacrylic acid at a mass ratio of 1:3 to 3:1. The reason therefor was described above and repetition thereof is thus omitted.

The first spinning solution may be electrospun under a voltage of 15 kV to 30 kV. If the voltage is less than 15 kV, the resultant electric field may be insufficient, making it difficult to realize the form of the first layer 221.

After electrospinning of the first spinning solution, the remaining solvent in the resulting product may be removed and hot rolling may be performed, thereby forming the first layer 221.

The thickness of the first layer 221 may be 1 μm to 20 μm. If the thickness of the first layer 221 is less than 1 μm, stable growth of lithium metal may not be induced.

The porosity of the first layer 221 may be 50% to 98%. If the porosity of the first layer 221 is less than 50%, the movement of lithium ions may not be smooth, and lithium metal deposited during charging may not be efficiently stored. If the porosity of the first layer 221 exceeds 98%, it is difficult for the first layer to maintain its shape, and durability may decrease.

The second spinning solution may be prepared by dissolving a styrene-butadiene-styrene block copolymer in an organic solvent.

The organic solvent is not particularly limited, and may include, for example, a mixed solvent of tetrahydrofuran and dimethylformamide at a mass ratio of 3:1.

The second spinning solution may include 9 wt % to 15 wt % of the styrene-butadiene-styrene block copolymer. If the amount of the styrene-butadiene-styrene block copolymer is less than 8 wt %, it is difficult to realize the form of the second layer 222, whereas if it exceeds 15 wt %, the second layer 222 may be non-uniformly formed.

The second spinning solution may be electrospun under a voltage of 15 kV to 30 kV. If the voltage is less than 15 kV, the resultant electric field may be insufficient, so it may be difficult to realize the form of the second layer 222.

After electrospinning of the second spinning solution, the remaining solvent in the resulting product may be removed, thereby forming the second layer 222.

The thickness of the second layer 222 may be 1 μm to 20 μm. If the thickness of the second layer 222 is less than 1 μm, structural stability may be deteriorated, whereas if it exceeds 20 μm, ionic resistance may be increased.

The porosity of the second layer 222 may be 50% to 90%. If the porosity of the second layer 222 is less than 50%, the movement of lithium ions may not be smooth. If the porosity of the second layer 222 exceeds 90%, it is difficult for the second layer to maintain its shape, and durability may decrease.

In one example, each thickness of the first and second layers 221 and 222 may mean a dimension of the element in a direction perpendicular to a planar surface of the element. The thickness of the element may be any one of an average thickness, a maximum thickness, a minimum thickness, or a thickness of the element measured in a predetermined region, unless contradictory to another definition explicitly described. In one example, the thickness of the element may be determined by defining a predetermined number (e.g., 5) of points to the left and the predetermined number (e.g., 5) of points to the right from a reference center point of the element at equal intervals (or non-equal intervals, alternatively), measuring a thickness of each of the points at equal intervals (or non-equal intervals, alternatively), and obtaining an average value therefrom. Alternatively, the thickness may be the maximum thickness or the minimum thickness of the multiple measurements. Alternatively, the thickness may be a thickness of the reference center point in the measured region. In one example, an optical microscope or a scanning electron microscope (SEM) may be used in the measurement, although the present disclosure is not limited thereto. Other measurement methods and/or tools appreciated by one of ordinary skill in the art, even if not described in the present disclosure, may also be used.

In one example, the porosity of the first and second layers 221 and 222 may be measured by a standard method that will be apparent to and understood by one of ordinary skill in the art. For example, a porosity of an element may be determined by measuring an average number of pores in a predefined region of the element. In one example, an optical microscope or a scanning electron microscope (SEM) may be used in the measurement, although the present disclosure is not limited thereto. Other measurement methods and/or tools appreciated by one of ordinary skill in the art, even if not described in the present disclosure, may also be used.

Separator

The separator 30 serves to prevent physical contact between the cathode 10 and the lithium electrode 20.

The separator 30 is not essential in the present disclosure, and the protective film 22 may perform the function of the separator 30.

Electrolyte

The electrolyte is responsible for movement of lithium ions between the cathode 10 and the lithium electrode 20, and may include an electrolytic solution, a lithium salt, and the like.

The electrolyte may be incorporated in all or part of the cathode 10 and the separator 30.

The electrolytic solution is a kind of organic solvent, and is not limited, so long as it is of a kind that is capable of being used in a lithium secondary battery. Examples thereof may include ethylene carbonate, propylene carbonate, dimethyl carbonate, diethyl carbonate, ethyl methyl carbonate, fluoroethylene carbonate, 1,2-dimethoxy ethane, 1,2-diethoxyethane, dimethylene glycol dimethyl ether, trimethylene glycol dimethyl ether, triethylene glycol dimethyl ether, tetraethylene glycol dimethyl ether, polyethylene glycol dimethyl ether, succinonitrile, sulfolane, dimethyl sulfone, ethyl methyl sulfone, diethyl sulfone, adiponitrile, 1,1,2,2-tetrafluoroethyl 2,2,3,3-tetrafluoropropyl ether, dimethylacetamide, and the like.

The lithium salt is not limited, so long as it is of a kind that is capable of being used in a lithium secondary battery, and examples thereof may include LiNO₃, LiPF₆, LiBF₆, LiCIO₄, LiCF₃SO₃, LiBr, LiI, and the like.

A better understanding of the present disclosure may be obtained through the following examples and comparative examples. However, these examples are not to be construed as limiting the technical spirit of the present disclosure.

### EXAMPLE

A first spinning solution was prepared by dissolving polyvinyl alcohol and polyacrylic acid at a mass ratio of 1:3 in water. The amount of polyvinyl alcohol and polyacrylic acid in the first spinning solution was 8 wt %.

The first spinning solution was electrospun on a copper substrate under a voltage of 20 kV to afford a first layer in the form of a mat. The remaining solvent in the first layer was dried, followed by hot rolling. The thickness of the first layer was about 20 μm.

A styrene-butadiene-styrene block copolymer was dissolved in a mixed solvent of tetrahydrofuran and dimethylformamide at a mass ratio of 3:1 to prepare a second spinning solution. The amount of the styrene-butadiene-styrene block copolymer in the second spinning solution was 10 wt %.

The second spinning solution was electrospun on the first layer under a voltage of 18 kV to afford a second layer in the form of a mat. The remaining solvent in the second layer was removed. The thickness of the second layer was about 10 μm.

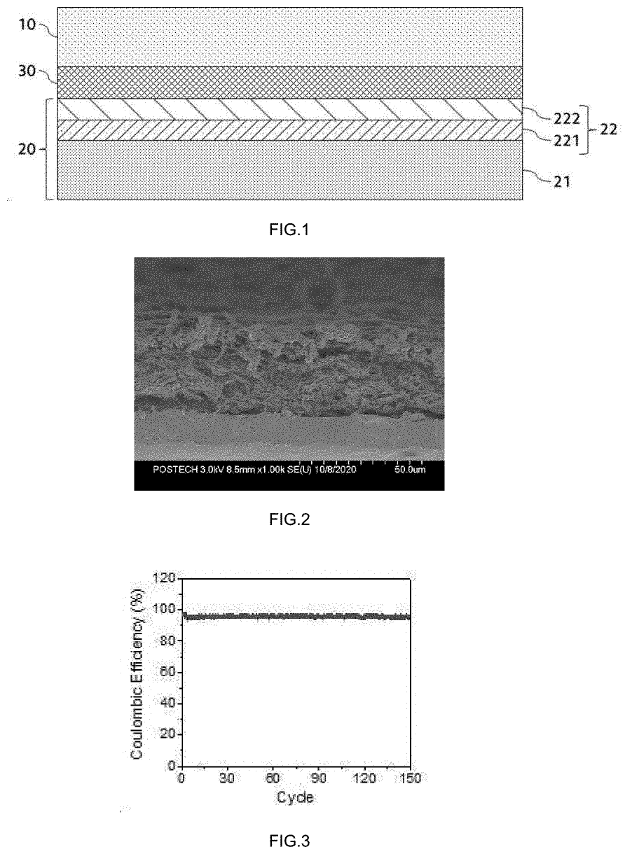

The cross section of the protective film including the first layer and the second layer was analyzed using a scanning electron microscope. The result thereof is shown in FIG. 2.

An asymmetric cell was manufactured using the protective film including the first and second layers as a working electrode and lithium metal as a counter electrode. A carbonate-based electrolytic solution and 1.0 M LiPF₆ were added into the asymmetric cell.

### Comparative Example 1

An asymmetric cell was manufactured in the same manner as in Example, with the exception that the second layer was not formed.

### Comparative Example 2

An asymmetric cell was manufactured in the same manner as in Example, with the exception that the first layer was not formed.

### Comparative Example 3

An asymmetric cell was manufactured in the same manner as in Example, with the exception that the second layer was formed to a thickness of 30 μm.

### Comparative Example 4

An asymmetric cell was manufactured using a pure copper current collector as a working electrode.

### Test Example

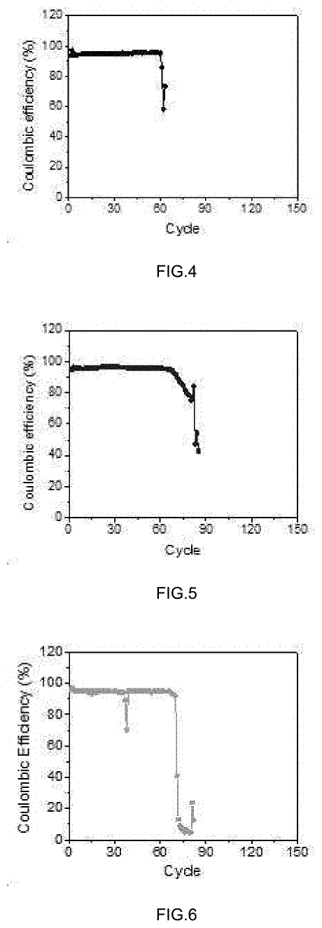

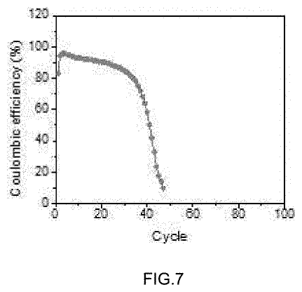

The electrochemical lifetime of the asymmetric cells according to Example and Comparative Examples 1 to 4 was evaluated. FIG. 3 shows the result of Example, and FIGS. 4 to 7 show the results of Comparative Examples 1 to 4, respectively. With reference thereto, the asymmetric cell according to Example exhibited high coulombic efficiency without a short circuit until the number of charging and discharging cycles exceeded 150, whereas all of Comparative Examples 1 to 4 caused a short circuit before 90 charging and discharging cycles.

Although specific embodiments of the present disclosure have been described with reference to the accompanying drawings, those skilled in the art will appreciate that various modifications and variations are possible from the above description. For example, even when the described techniques are performed in an order different from the described method, and/or even when the described components are coupled or combined in a different form from the described method or are replaced or substituted by other components or equivalents, appropriate results can be achieved. Therefore, other implementations, other embodiments, and equivalents to the claims also fall within the scope of the following claims.

What is claimed is:

1. A protective film for a lithium electrode, comprising:
a first layer comprising polyvinyl alcohol (PVA) and polyacrylic acid (PAA), wherein the first layer is porous; and
a second layer comprising a styrene-butadiene-styrene block copolymer, wherein the second layer is disposed on the first layer and is porous.

2. The protective film of claim 1, wherein the first layer comprises the PVA and the PAA at a mass ratio of 1:3 to 3:1.

3. The protective film of claim 1, wherein the first layer has a structure formed by accumulating nanofibers in which a spinning solution comprising the PVA and the PAA is electrospun.

4. The protective film of claim 1, wherein the first layer has a thickness of 1 μm to 20 μm.

5. The protective film of claim 1, wherein the first layer has a porosity of 50% to 98%.

6. The protective film of claim 1, wherein the second layer has a structure formed by accumulating nanofibers in which a spinning solution comprising a styrene-butadiene-styrene block copolymer is electrospun.

7. The protective film of claim 1, wherein the second layer has a thickness of 1 μm to 20 μm.

8. The protective film of claim 1, wherein the second layer has a porosity of 50% to 90%.

9. A lithium electrode for a lithium secondary battery, comprising:
a plate-shaped lithium metal; and
the protective film of claim 1 disposed on the lithium metal, wherein the first layer of the protective film is disposed on the lithium metal.

10. A method of manufacturing a protective film for a lithium electrode, comprising:
preparing a first spinning solution comprising polyvinyl alcohol (PVA) and polyacrylic acid (FAA);
forming a first layer by electrospinning the first spinning solution on a substrate, wherein the first layer is porous;
preparing a second spinning solution comprising a styrene-butadiene-styrene block copolymer; and
forming a second layer by electrospinning the second spinning solution on the first layer, wherein the second layer is porous.

11. The method of claim 10, wherein the first spinning solution comprises 8 wt % to 15 wt % of the PVA and the PAA.

12. The method of claim 10, wherein the first spinning solution comprises the PVA and the PAA at a mass ratio of 1:3 to 3:1.

13. The method of claim 10, wherein the first spinning solution is electrospun under a voltage of 15 kV to 30 kV.

14. The method of claim 10, wherein, after electrospinning the first spinning solution, a resulting product is hot-rolled to form the first layer.

15. The method of claim 10, wherein the first layer has a thickness of 1 μm to 20 μm.

16. The method of claim 10, wherein the first layer has a porosity of 50% to 98%.

17. The method of claim 10, wherein the second spinning solution comprises 9 wt % to 15 wt % of the styrene-butadiene-styrene block copolymer.

18. The method of claim 10, wherein the second spinning solution is electrospun under a voltage of 15 kV to 30 kV.

19. The method of claim 10, wherein the second layer has a thickness of 1 μm to 20 μm.

20. The method of claim 10, wherein the second layer has a porosity of 50% to 90%.
